(19) United States
(12) Patent Application Publication
(10) Pub. No.: US 2006/0007692 A1
(43) Pub. Date: Jan. 12, 2006

(54) Lamp assembly

(76) Inventor: Chen Shih Hsien, Tainan City (TW)

Correspondence Address: Keith Kline;PRO-TECHTOR INTERNATIONAL SERVICES, 20775 Norada Court, Saratoga, CA, 95070-3018, US

(21) Appl. No.: 10/887,503

(22) Filed: Jul. 7, 2004

(51) Int. Cl. F21V 19/00

(52) U.S. Cl. 362/382

(57) ABSTRACT

A lamp assembly is disclosed to include a bottom holder shell holding a light source, the bottom holder shell having faceted lens elements in the inside wall for reflecting and refracting light from the light source, an upper holder shell holding an inner lens above the light source, the upper holder shell having faceted lens elements in the inside wall for reflecting and refracting light from the light source, the inner lens having facets for reflecting and refracting light, and a transparent lens covering the top open side of the upper holder shell for refracting light from the inside of the upper holder shell to the outside in different directions to produce glorious luster.

### BACKGROUND OF THE INVENTION

1. Field of the Invention

The present invention relates to lamps and more particularly, to a lamp assembly that produces glorious luster.

2. Description of the Related Art

FIG. 1 illustrates a lamp assembly according to the prior art. This design of lamp assembly is suitable for use as a vehicle side lamp or projection light. As illustrated, the lamp assembly comprises a lamp case 10, a lens 20 covered on the lamp case 10, and a lamp bulb 30 mounted inside the lamp case 10. The lamp case 10 has a plurality of reflecting surface portions 101 on the inside wall for reflecting light from the lamp bulb 30. FIGS. 2 and 3 show another two different designs of lamp assembly according to the prior art. According to the design shown in FIG. 2, the lamp case 10 has a plurality of raised lens elements 102 on the inside wall for reflecting and refracting light from the lamp bulb (not shown). According to the designs shown in FIGS. 2 and 3, the lens 20 has facets 201 for refracting light toward different directions. These conventional designs of lamp assembly have been appeared on the market for long, and are loosing their attraction to consumers gradually.

### SUMMARY OF THE INVENTION

The present invention has been accomplished under the circumstances in view. It is one object of the present invention to provide a lamp assembly that produces glorious luster to attract consumers. It is another object of the present invention to provide a lamp assembly, which uses a diamond-like or faceted lens to reflect and refract light, producing glorious luster.

To achieve these and other objects of the present invention, the lamp assembly comprises a light-tight bottom holder shell, the light-tight bottom holder shells having a plurality of faceted lens elements protruded from an inside wall thereof for reflecting and refracting light, a top open side, and a center through hole cut through the center of a bottom wall thereof; a light source mounted inside the bottom holder shell, the light source having a power cord extended out of the center through hole of the bottom holder shell; a double-open-end light-tight upper holder shell fastened to the top open side of the light-tight bottom holder shell, the double-open-end light-tight upper holder shell having a plurality of faceted lens elements protruded from an inside wall thereof for reflecting and refracting light; an inner lens shaped like a cut gemstone and set between the light-tight bottom holder shell and the double-open-end light-tight upper holder shell, the inner lens having a plurality of facets for reflecting and refracting light; and at least one transparent outer lens fixedly fastened to the double-open-end light-tight upper holder shell over a top open side of the double-open-end light-tight upper holder shell, each the transparent outer lens having a plurality of facets at an outer side thereof.

### BRIEF DESCRIPTION OF THE DRAWINGS

FIG. 1 is a perspective view of a lamp assembly according to the prior art.

FIG. 2 is a perspective view of another design of lamp assembly according to the prior art (the light source not shown).

FIG. 3 is a perspective view of still another design of lamp assembly according to the prior art (the light source not shown).

FIG. 4 is an exploded view of a lamp assembly according to the present invention.

FIG. 5 is a sectional assembly view of the lamp assembly according to the present invention.

FIG. 6 is a perspective view of the lamp assembly according to the present invention.

FIG. 7 is an exploded view of an alternate form of the lamp assembly according to the present invention.

FIG. 8 is a sectional assembly view of the alternate form of lamp assembly shown in FIG. 7.

FIG. 9 is an exploded view of another alternate form of the lamp assembly according to the present invention.

FIG. 10 is a schematic drawing showing an installation example of the alternate form of the lamp assembly shown in FIG. 9.

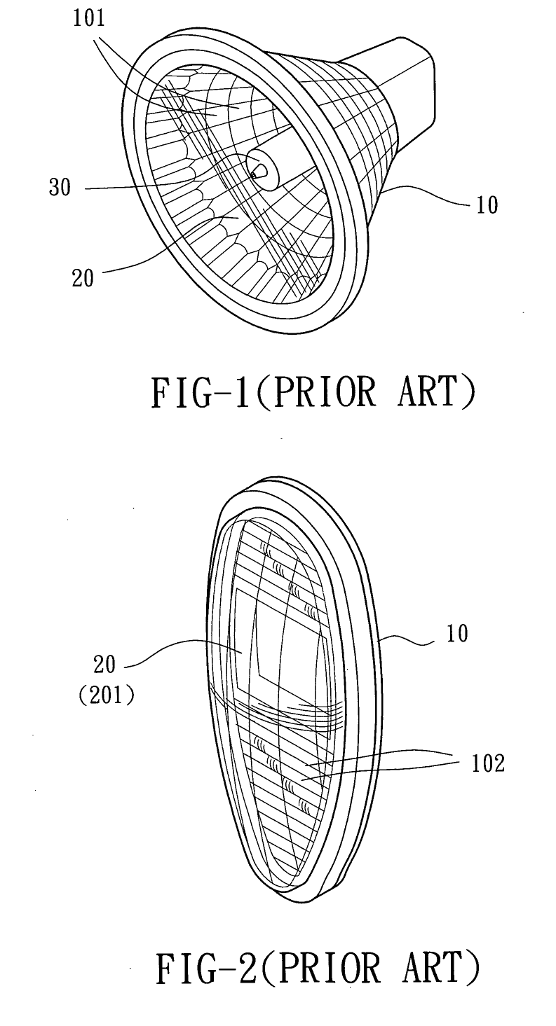

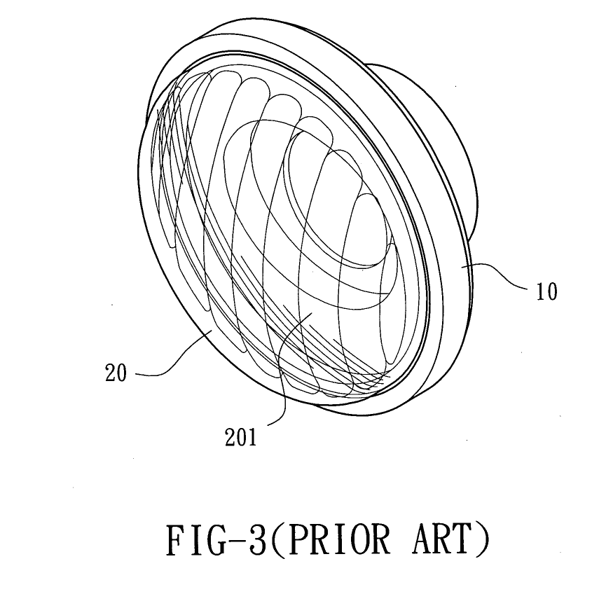

### DETAILED DESCRIPTION OF THE PREFERRED EMBODIMENT

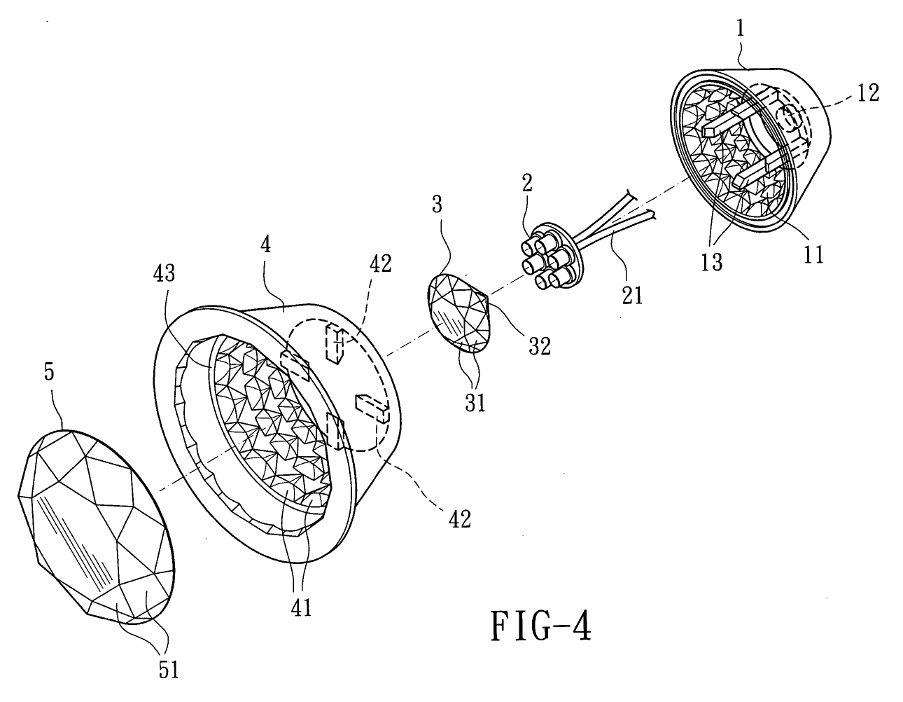

Referring to FIG. 4, a lamp assembly in accordance with the present invention is shown comprised of a light-tight bottom holder shell 1, a light-tight light source 2, an inner lens 3, an upper holder shell 4, and an outer lens 5.

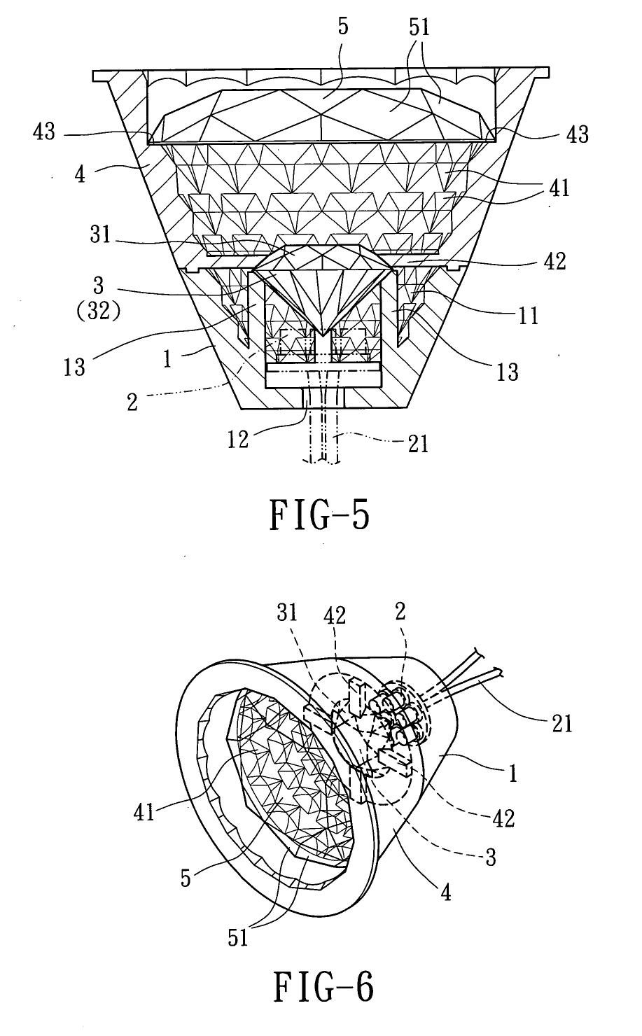

Referring to FIGS. 5 and 6 and FIG. 4 again, the bottom holder shell 1 is shaped like a bowl, having a plurality of faceted lens elements 11 protruded from the inside wall for reflecting and refracting light, a plurality of support rods 13 equiangularly spaced around the inside wall, and a center through hole 12 cut through the center of the bottom wall. The light source 2 is mounted inside the bottom holder shell 1, and having a power cord 21 extended out of the bottom holder shell 1 through the center through hole 12 (see FIG. 5). The light source 2 can be formed of at last one LED (light emitting diode) or lamp bulb. According to the present preferred embodiment, the light source 2 is formed of a number of LEDs. The inner lens 3 is shaped like a cut gemstone and provided above (in front of) the light source 2 to reflect and refract light from the light source 2, having a plurality of first facets 31 around the periphery of the crown thereof and a plurality of second facets 32 around the periphery of the pavilion thereof. The first facets 31 can be made having a triangular or rhombic shape. The upper holder shell 4 is a double-open-end hollow shell fixedly to the top open side of the bottom holder shell 1, having a plurality of locating rods 42 radially suspended in the bottom open side thereof and holding down the inner lens 3 on the support rods 13 of the bottom holder shell 1 above the light source 2 (see FIGS. 5 and 6), a plurality of faceted lens elements 41 protruded from the inside wall thereof for refracting light, and a positioning groove 43 extended around the inside wall thereof near the top open side. The outer lens 5 is a transparent member fixedly secured to the positioning groove 43 of the upper holder shell 4, having a plurality of facets 51 at the outer side.

Referring to FIGS. 4˜6 again, when turned on the light source 2, light from the light source 2 is reflected and refracted by the faceted lens elements 11 of the bottom holder shell 1 and the faceted lens elements 41 of the upper holder shell 4 and the facets 31, 32 of the inner lens 3, enabling reflected and refracted light rays to pass through the facets 51 of the outer lens 5 in different directions, thereby producing glorious luster. When the light source 2 is off, the faceted lens elements 11, 41 of the holder shells 1, 4 and the facets 31, 32, 51 of the lenses 3, 5 reflect and refract incident light, thereby producing glorious luster.

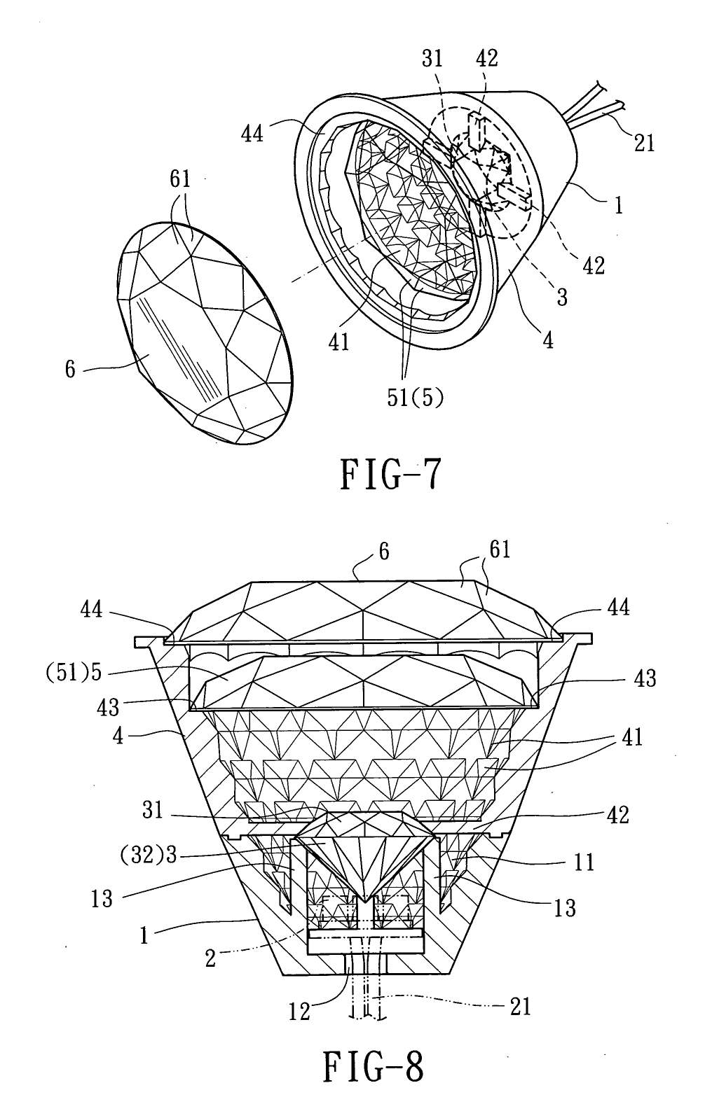

FIGS. 7 and 8 show an alternate form of the present invention. According to this alternate form of the present invention, the upper holder shell 4 further comprises a second positioning groove 44 for the positioning of a second outer lens 6 above the outer lens 5. The second outer lens 6 is a transparent member having a plurality of facets 51 at the outer side.

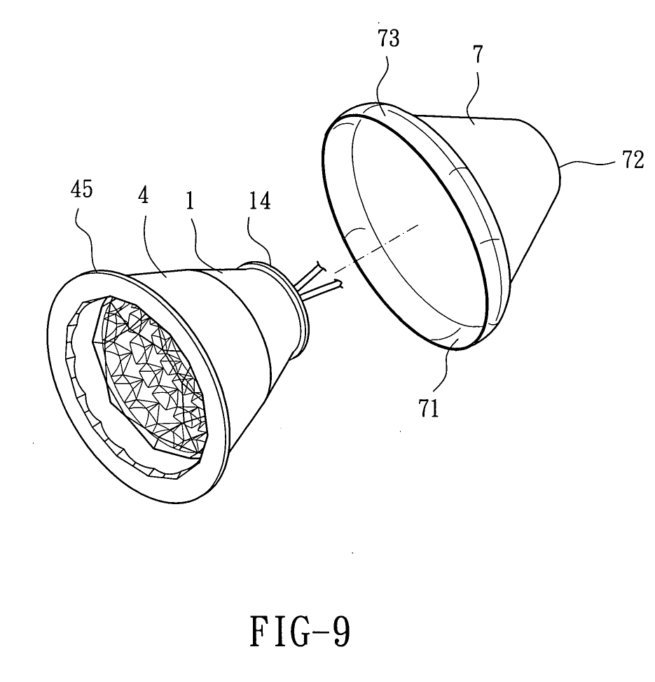

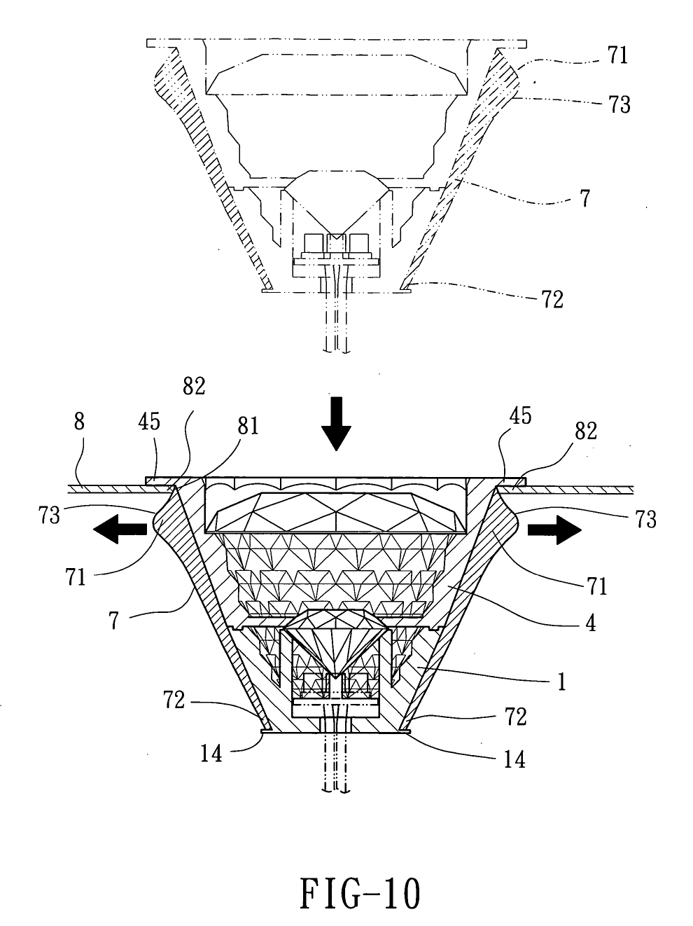

FIGS. 9 and 10 show another alternate form of the present invention. According to this embodiment, the bottom holder shell 1 has a bottom locating flange 14 extended around the periphery of the bottom side thereof; the upper holder shell 4 has a top locating flange 45 extended around the periphery of the top open side thereof; a plastic or rubber cover shell 7 is covered on the periphery of the bottom holder shell 1 and the periphery of the upper holder shell 4, having a bottom edge 72 stopped at the top side of the bottom locating flange 14 of the bottom holder shell 1 and a top flange 71 stopped at the bottom side of the top locating flange 45 of the upper holder shell 4. During installation, the cover shell 7 is inserted with the lamp assembly through the mounting hole 81 in the ceiling 8 from the top side toward the bottom side, keeping the top locating flange 45 of the upper holder shell 4 and the top edge 73 of the top flange 71 of the cover shell 7 respectively stopped against the top and bottom side of the peripheral wall 82 of the mounting hole 81 in the ceiling 8.

A prototype of lamp assembly has been constructed with the features of FIGS. 4˜10. The lamp assembly functions smoothly to provide all of the features discussed earlier.

Although particular embodiments of the invention have been described in detail for purposes of illustration, various modifications and enhancements may be made without departing from the spirit and scope of the invention.

What the invention claimed is:

1. A lamp assembly comprising:
a light-tight bottom holder shell, said light-tight bottom holder shells having a plurality of faceted lens elements protruded from an inside wall thereof for reflecting and refracting light, a top open side, and a center through hole cut through the center of a bottom wall thereof;
a light source mounted inside said bottom holder shell, said light source having a power cord extended out of the center through hole of said bottom holder shell;
a double-open-end light-tight upper holder shell fastened to the top open side of said light-tight bottom holder shell, said double-open-end light-tight upper holder shell having a plurality of faceted lens elements protruded from an inside wall thereof for reflecting and refracting light;
an inner lens set between said light-tight bottom holder shell and said double-open-end light-tight upper holder shell, said inner lens having a plurality of facets for reflecting and refracting light; and
at least one transparent outer lens fixedly fastened to said double-open-end light-tight upper holder shell over a top open side of said double-open-end light-tight upper holder shell, each said transparent outer lens having a plurality of facets at an outer side thereof.

2. The lamp assembly as claimed in claim 1, wherein said double-open-end light-tight upper holder shell comprises two inside positioning grooves disposed at different elevations near the top open side of said double-open-end light-tight upper holder shell; the number of said at least one transparent outer lens is 2, and the two transparent outer lenses are respectively positioned in the two inside positioning grooves of said double-open-end light-tight upper holder shell.

3. The lamp assembly as claimed in claim 1, wherein said light-tight bottom holder shell comprises a plurality of equiangularly spaced inside support rods adapted to support said inner lens above said light source; said double-open-end light-tight upper holder shell comprises a plurality of radial locating rods radially suspended in a bottom open side thereof and holding down said inner lens on the support rods of said bottom holder shell above said light source.

4. The lamp assembly as claimed in claim 1, further comprising a springy cover shell covered on the periphery of said light-tight bottom holder shell and the periphery of said double-open-end light-tight upper holder shell, said springy cover shell having a bottom edge stopped against a bottom locating flange of said light-tight bottom holder shell and a top flange stopped against a top locating flange of said double-open-end light-tight upper holder shell.
